(19) United States
(12) Patent Application Publication
(10) Pub. No.: US 2006/0278053 A1
(43) Pub. Date: Dec. 14, 2006

(54) Cutting device for cutting a curtain fabric and method for cutting a curtain fabric

(76) Inventor: Dominique Lampe, Roeselare (BE)

Correspondence Address: James C. Wray, Suite 300, 1493 Chain Bridge Road, McLean, VA, 22101, US

(21) Appl. No.: 11/433,788

(22) Filed: May 12, 2006

(30) Foreign Application Priority Data
May 12, 2005 (BE) 2005/0239

(51) Int. Cl. B26D 7/06

(52) U.S. Cl. 83/78

(57) ABSTRACT

In a method for cutting a curtain fabric, the said curtain fabric is positioned on a supporting surface and the curtain fabric is cut. After the curtain fabric has been positioned on the supporting surface, the supporting surface is moved into a virtually vertical position and back to a horizontal position and the curtain fabric is cut. A cutting device for cutting a curtain fabric has a supporting surface which is moved between a horizontal and virtually vertical position for the said curtain fabric. Cutting curtain fabrics using this method produces curtains which, after they have been hung, no longer start to hang in a skew position.

This application claims the benefit of Belgian Application No. 2005/0239 filed May 12, 2005, which is hereby incorporated by reference in its entirety.

### SUMMARY OF THE INVENTION

The present invention relates firstly to a method for cutting a curtain fabric, in which:
the said curtain fabric is positioned on a supporting surface;
the curtain fabric is cut.

Secondly, the present invention relates to a cutting device for cutting a curtain fabric, comprising a supporting surface for the said curtain fabric.

In the context of the present patent application, a curtain fabric is to be understood as meaning a fabric with the selvedge located at the top and bottom, as seen in the weaving direction.

Curtains are in widespread use as window decoration. The curtains are cut to size with the aid of, for example, a laser cutting machine. For this purpose, the curtain fabric is positioned via its selvedge (which is always straight) on a horizontal cutting table. Then, the cutting lines are marked out perpendicular to the selvedge and the curtain is cut to size, for example via a laser beam.

It has been found that curtains, notwithstanding the straight cutting lines, after they have been hung can start to hang in a skew position as a result of the woven structure and certain properties (for example stretching) of the material. This is more particularly the case if the fabrics used are cotton or linen (materials which inherently stretch to some extent).

The object of the present invention is to provide a method for cutting curtain fabrics in which the curtain, after it has been hung, no longer hangs in a skew position.

The object of the invention is achieved by providing a method for cutting a curtain fabric, in which:
the said curtain fabric is positioned on a supporting surface;
the curtain fabric is cut;
   wherein after the curtain fabric has been positioned on the supporting surface, the supporting surface is moved into a virtually vertical position. Moving the supporting surface into a virtually vertical position means that the curtain fabric will hang straight, in the same way as it will hang in practice for example at a window.

Using the present method prevents the curtain from hanging in a skew position in front of a window after it has been cut.

These and further and other objects and features of the invention are apparent in the disclosure, which includes the above and ongoing written specification, with the claims and the drawings.

### BRIEF DESCRIPTION OF THE DRAWINGS

FIG. 1 schematically represents steps of the method and elements of the apparatus.

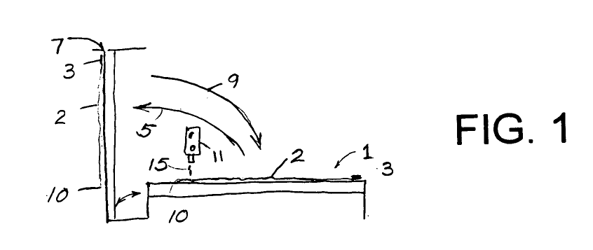

### DETAILED DESCRIPTION OF THE PREFERRED EMBODIMENTS

In a particular method 1 according to the invention, the positioning of the said fabric 2 takes place on a horizontal supporting surface 4.

In a more particular method according to the invention, the curtain fabric 2, via its upper selvedge 3, is secured to the supporting surface 4 parallel to the top side 6 of the supporting surface.

In a preferred method according to the invention, the curtain fabric 2 is cut in a virtually horizontal position 8 of the supporting surface 4.

Another subject of the present patent application is a cutting device 1 for cutting a curtain fabric 2, comprising a supporting surface 4 for the said curtain fabric, wherein the cutting device is intended to move 5 the supporting surface into a virtually vertical position 10.

The said device is preferably used in the method according to one of claims 1 to 4.

To further explain the properties of the present invention and to indicate additional advantages and details thereof, there now follows a more detailed description of the method used and of a cutting device 1 for cutting fabrics 2. It will be clear that none of the information to be found in the description which follows can be interpreted as restricting the scope of protection as laid down in the claims for the present invention.

To prevent curtains 2 from starting to hang in a skew position after they have been hung, the curtain fabric is first of all allowed to hang in the same way as it would normally hang in practice.

In the method according to the invention, the curtain fabric is first of all positioned, via its upper selvedge 3, on the supporting surface 4 of a cutting device 1. The upper selvedge 3 is fixed to the top side 6 of the said supporting surface.

Then, the supporting surface is moved 5 into a virtually vertical position 12, with the result that the curtain fabric 2 starts to hang down. After the curtain fabric has been hung, the supporting surface returns 9 to its starting position 8 (horizontal) and the curtain fabric is cut via a laser cutting device 11 in directions 15.

Cutting curtain fabrics using this method produces curtains which, after they have been hung, no longer start to hang in a skew position.

While the invention has been described with reference to specific embodiments, modifications and variations of the invention may be constructed without departing from the scope of the invention, which is defined in the following claims.

I claim:

1. Method for cutting a curtain fabric, in which:
the said curtain fabric is positioned on a supporting surface;
the curtain fabric is cut
characterized in that after the curtain fabric has been positioned on the supporting surface, the supporting surface is moved into a virtually vertical position.

2. Method for cutting a curtain fabric according to claim 1, characterized in that the positioning of the said fabric takes place on a horizontal supporting surface.

3. Method for cutting a curtain fabric according to claim 1, characterized in that the curtain fabric, via its upper selvedge, is secured to the supporting surface parallel to the top side of the supporting surface.

4. Method for cutting a curtain fabric according to claim 1, characterized in that the curtain fabric is cut in a virtually horizontal position of the supporting surface.

5. Cutting device for cutting a curtain fabric, comprising a supporting surface for the said curtain fabric, characterized in that the cutting device is intended to move the supporting surface into a virtually vertical position.

6. Cutting device according to claim 5, characterized in that the device is provided with a laser cutting device for cutting the curtain fabric.

7. Cutting device according to claim 5, characterized in that the said device is used in the method in which:
the said curtain fabric is positioned on a supporting surface;
the curtain fabric is cut
characterized in that after the curtain fabric has been positioned on the supporting surface, the supporting surface is moved into a virtually vertical position.
